(19) United States
(12) Patent Application Publication
(10) Pub. No.: US 2019/0247154 A1
(43) Pub. Date: Aug. 15, 2019

(54) Gingival Tissue Former

(71) Applicant: David J. Rallis, Lincoln, NE (US)

(72) Inventor: David J. Rallis, Lincoln, NE (US)

(21) Appl. No.: 16/381,700

(22) Filed: Apr. 11, 2019

Related U.S. Application Data
(63) Continuation-in-part of application No. 15/924,131, filed on Mar. 16, 2018.
Application No. 15/924,131 is a continuation of application No. 15/870,214, filed on Jan. 12, 2018, now abandoned.
(60) Provisional application No. 62/662,110, filed on Apr. 24, 2018.
(60) Provisional application No. 62/754,892, filed on Nov. 2, 2018.
(60) Provisional application No. 62/445,480, filed on Jan. 12, 2017.

(51) Int. Cl. A61C 8/00

(52) U.S. Cl. CPC A61C 8/0077; A61C 8/0093; A61C 8/005; A61C 8/008; A61C 8/0001

(57) ABSTRACT

A process for providing a gingival tissue former may include, but is not limited to: capturing a cross-sectional image of a representation of a tooth in a digital scan, perpendicular to a reference axis, at a specified reference level; modifying an orientation of the cross-sectional image to correspond to a standard orientation; applying one or more image processing techniques to the cross-sectional image to generate a tooth shape image; and mapping the tooth shape image to one or more design specifications for a gingival tissue former.

### CROSS-REFERENCE TO RELATED APPLICATIONS

The present application claims priority under 35 U.S.C. § 119(e) to U.S. Provisional Patent Application Ser. No. 62/445,480, entitled GINGIVAL HEALING TISSUE FORMER WITH INTEGRATED SCAN BODY, filed Jan. 12, 2017, naming David J. Rallis as an inventor, which is incorporated herein by reference in the entirety.

The present application also claims priority under 35 U.S.C. § 120 to U.S. Nonprovisional patent application Ser. No. 15/870,214, entitled GINGIVAL HEALING TISSUE FORMER WITH INTEGRATED SCAN BODY, filed Jan. 12, 2018, naming David J. Rallis as an inventor, which is incorporated herein by reference in the entirety

The present application also claims priority under 35 U.S.C. § 120 to U.S. Nonprovisional patent application Ser. No. 15/924,131, entitled GINGIVAL TISSUE FORMER, filed Mar. 16, 2018, naming David J. Rallis as an inventor, which is incorporated herein by reference in the entirety.

The present application also claims priority under 35 U.S.C. § 119 to U.S. Provisional Patent Application Ser. No. 62/662,110, entitled PROCESS FOR DETERMINATION OF IMPLANT POSITIONING TO FACILITATE THE IDEAL ANATOMIC ROOT-FORM DESIGN FOR TISSUE FORMING HEALING ABUTMENTS, filed Apr. 24, 2018, naming David J. Rallis as an inventor, which is incorporated herein by reference in the entirety.

The present application also claims priority under 35 U.S.C. § 119 to U.S. Provisional Patent Application Ser. No. 62/754,892, entitled GINGIVAL TISSUE FORMERS, filed Nov. 7, 2018, naming David J. Rallis as an inventor, which is incorporated herein by reference in the entirety.

### TECHNICAL FIELD

The present invention generally relates to a healing abutment for dental implantation, and more particularly, to a gingival tissue former for dental implantation.

### BACKGROUND

Dental implant surgery is performed to replace a single tooth, more than one tooth, or all of the teeth, in order to restore function as well as aesthetics. Dental implant surgery in general is categorized into two procedures, two-stage or single-stage implant.

A two-stage dental implant typically begins with a placement of an endosseous implant (i.e., implant fixture) in maxilla or mandible. A cover screw is used to cover an opening of the dental implant fixture and an incision (i.e., gingival tissue) is sutured to cover the dental implant fixture. After osseointegration takes place (e.g., 3-6 months), a clinician must make a surgical incision again to access the dental implant fixture, place a healing abutment over the implant fixture, and reposition the gingival tissue around the healing abutment with a suture, which is then allowed to heal. The two-stage dental implant is used when quality and/or quantity of jawbone is poor and requires two surgical procedures.

A single-stage dental implant involves surgically placing a dental implant fixture in maxilla or mandible followed by leaving the dental implant fixture head (e.g., a healing abutment) visible by positioning and suturing the gingival tissue. The single-stage dental implant is generally used when the jawbone quality is good and good initial implant stability is guaranteed and requires one surgical procedure. After the osseointegration takes place (e.g., 3-6 months) for both two-stage and one-stage dental implant procedures, a clinician must remove the healing abutment that was embedded within the gingival tissue and place a scan body temporarily over the dental implant fixture for three-dimensional optical scanning so that a dental restoration can be fabricated. The scan body is later replaced with a dental prosthesis. Another method for obtaining a model of the implant relative to an oral cavity structure is to couple a transfer coping (e.g., impression coping) to the dental implant fixture, which results in an impression of the oral cavity structure being taken. In order to accomplish this task, the transfer coping is screwed into the dental implant fixture and then the transfer coping gets picked up in the impression so that a model can be formed around the impression coping. A restoration can subsequently be constructed by pouring a model in a stone model with an imbedded implant analog. The replication of the mouth and the exact position of the dental implant fixture allow for the final crown that will be cemented into the dental implant fixture to be fabricated.

However, one of the issues encountered in these procedures was that healing abutments inadequately address the aesthetic needs for implant restoration, as many manufactured healing abutments are typically cylindrical in shape and are not geometrically designed to shape gingival (i.e., gum) tissue to anatomic form. In this regard, this approach results in gingival tissue distortion at the time of scanning for dental restoration and the dental restoration does not mimic a natural tooth and periodontium without additional tissue development. Additionally, this approach significantly influences workflow by a need to remove the healing abutments placed over the implant fixture, placing the scan body temporarily over the implant fixture, and removing the scan body after taking an impression for the dental restoration.

### SUMMARY

A process for providing a gingival tissue former may include, but is not limited to: capturing a cross-sectional image of a representation of a tooth in a digital scan, perpendicular to a reference axis, at a specified reference level; modifying an orientation of the cross-sectional image to correspond to a standard orientation; applying one or more image processing techniques to the cross-sectional image to generate a tooth shape image; and mapping the tooth shape image to one or more design specifications for a gingival tissue former.

### BRIEF DESCRIPTION OF THE DRAWINGS

The numerous advantages of the disclosure may be better understood by those skilled in the art by reference to the accompanying figures in which:

FIG. 1A illustrates a prospective view of a gingival tissue former;

FIG. 1B illustrates an elevational side view of a gingival tissue former;

FIG. 1C illustrates an elevational bottom view of a gingival tissue former;

FIG. 2A illustrates an elevational side view of an alternative shape of a gingival tissue former;

FIG. 2B illustrates an elevational side view of an alternative shape of a gingival tissue former;

FIG. 2C illustrates an elevational side view of an alternative shape of a gingival tissue former;

FIG. 3 illustrates a gingival tissue former kit;

FIG. 4 illustrates a dental implant assembly of a gingival tissue former;

FIG. 5 illustrates a placement of a connector into a dental implant fixture;

FIG. 6 illustrates a placement of a gingival tissue former over a connector;

FIG. 7 illustrates a configuration of a gingival tissue former;

FIG. 8 illustrates a step for removing a gingival tissue former and/or a connector;

FIG. 9 illustrates a placement of a restoration over a dental implant fixture;

FIG. 10 illustrates a final step of a dental implant procedure;

FIG. 11A illustrates an installation method of a gingival tissue forming system;

FIG. 11B illustrates a second installation method of a gingival tissue forming system;

FIG. 11C illustrates a third installation method of a gingival tissue forming system;

FIG. 12A illustrates another coupling method between a gingival tissue former and a dental connector;

FIG. 12B illustrates an elevational bottom view of the gingival tissue former shown in FIG. 12a;

FIG. 13 illustrates a process for providing a gingival tissue former;

FIG. 14 illustrates a reference coordinate set for image analysis of a tooth;

FIG. 15 illustrates a reference coordinate set for image analysis of a tooth;

FIG. 16 illustrates a reference coordinate set defining a cross-sectional image of a tooth;

FIG. 17 illustrates a reference coordinate set defining a cross-sectional image of a tooth;

FIG. 18 illustrates a reference coordinate set defining a cross-sectional image of a tooth;

FIG. 19A illustrates a reference coordinate set defining a cross-sectional image of a tooth;

FIG. 19B illustrates a reference coordinate set defining a cross-sectional image of a tooth;

FIG. 19C illustrates a reference coordinate set defining a cross-sectional image of a tooth;

FIG. 20 illustrates a tooth boundary in a cross-sectional image of a tooth;

FIG. 21 illustrates virtual placement of a dental implant relative to an optical scan and a CT scan;

FIG. 22 illustrates a coordinate set for alignment of two or more cross-sectional images;

FIG. 23 illustrates a coordinate set for alignment of two or more cross-sectional images;

FIG. 24 illustrates a cross-sectional image of a tooth following image processing; and

FIG. 25 illustrates a cross-sectional image of a tooth following image processing.

### DETAILED DESCRIPTION OF THE INVENTION

Reference will now be made in detail to the subject matter disclosed, which is illustrated in the accompanying drawings.

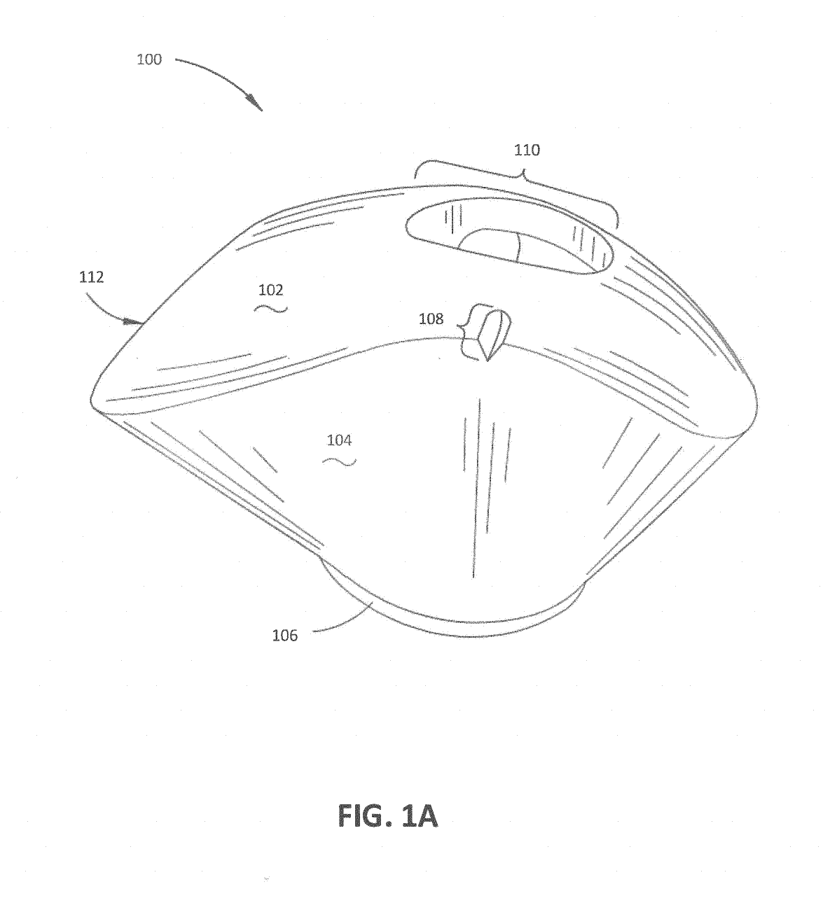

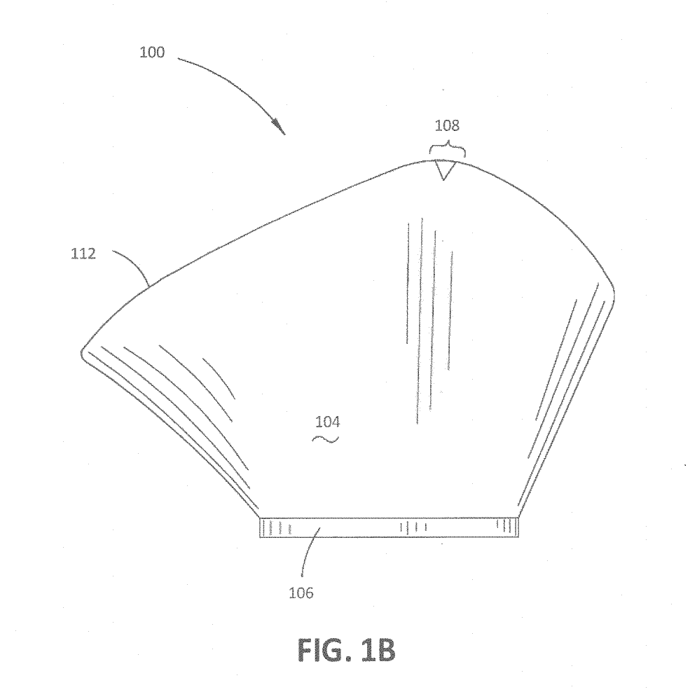

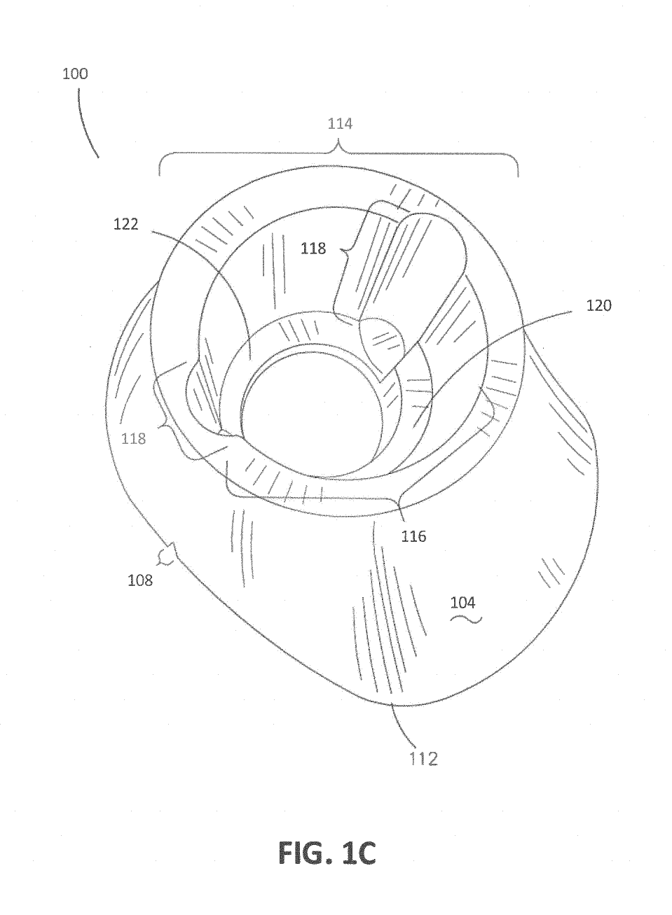

Referring generally to FIGS. 1A through 12B, the present disclosure is generally directed to a healing abutment for dental implantation. The present disclosure is further directed to a gingival tissue former allowing for shaping gingival tissue in anatomic form so as to match a natural appearance. Further, embodiments of the present disclosure allow for adjusting dimension and shape of the gingival tissue former to accommodate each individual's tooth for a better aesthetic finish. Additional embodiments of the present disclosure allow for the gingival tissue former to work as a scan body for fabricating a dental restoration without removing the gingival tissue former (i.e., a healing abutment) from a dental implant fixture and placing a scan body temporarily over the dental implant fixture.

As used throughout the present disclosure, the term “osseointegration” generally refers to the direct structural and functional connection between living bone and the surface of a load-bearing. For example, osseointegration for dental implants may refer to form an intimate bond between the dental implant and a bone of the jaw.

As used throughout the present disclosure, the term “Ti-base” generally refers to a connector made from Titanium material that firmly connects an abutment and a dental implant fixture. For example, Ti-base may be made universally to fit various abutments and dental implant fixtures. It is noted that the terms “temporally coping”, “temporally cylinder”, and “stock abutment” may be used interchangeably with “Ti-base”. A Ti-base may include Staumann® Variobase® or On1™ systems.

As used throughout the present disclosure, the term “healing abutment” generally refers to an abutment attached directly on top of a dental implant fixture to effectively increase a length of the dental implant. This ensures that the healing abutment protrudes through a gum tissue (i.e., gingival tissue) and prevents gum tissue from growing over the dental implant.

As used throughout the present disclosure, the term “transfer coping” generally refers to a manufactured device that duplicates the shape and position of an abutment interface of a dental implant fixture in an impression in order to accurately position the dental implant analog in an operative model.

As used throughout the present disclosure, the term “scan body” generally refers to a device that temporarily attaches to a dental implant fixture before scanning to create a digital representation of a teeth, providing for the exact position of the implant in the scanned model.

Now referring to FIG. 1A, FIG. 1A illustrates a prospective view of a gingival tissue former 100. In one embodiment, a gingival tissue former 100 includes a top surface 102, side surface 104 (i.e., a lateral surface), and a base 106 (i.e., defining a bottom surface) constituting a body (i.e., a tissue former) of the gingival tissue former 100. For example, the top surface 102 of the gingival tissue former 100 may be configured to generally shape as a top surface of a tooth. For instance, the top surface 102 of the gingival tissue former 100 may have a curvature similar to a tooth. In this regard, a shape and dimension of the top surface 102 of the gingival tissue former 100 may vary based on types of a tooth such as, but is not limited to, molar, bicuspid, cuspid, or incisor.

It is contemplated that, while the top surface 102 of the gingival tissue former 100 depicted in FIG. 1A is shown as a smooth surface (i.e., an even surface), such a configuration is merely provided for illustrative purposes. The embodiments of the present disclosure may be configured to adapt various shapes and curvature similar to a human tooth resulting in non-smooth surface (i.e., uneven surface).

In one embodiment, the gingival tissue former 100 includes an edge 112 (i.e., a perimeter) created by the top surface 102 of the gingival tissue former 100 and the side surface 104 of the gingival tissue former 100. Shapes and lengths of perimeter of the edge 112 of the gingival tissue former 100 may vary depending on dimensions and types of a tooth being treated by a dental implant procedure. For example, the edge of the gingival tissue former 100 for a molar tooth may have a longer perimeter than that for a bicuspid tooth. By way of another example, shapes of the edge 112 may differ depending on types of a tooth being treated by a dental implant procedure. For instance, molar teeth may have more tri-lobe (oval) shape than bicuspid teeth.

In one embodiment, the gingival tissue former 100 includes an aperture 110 disposed within the gingival tissue former 100. For example, a first end of the aperture 110 may be connected to the top surface 102 of the gingival tissue former 100 and a second end of the aperture 110 may be connected to a bottom surface of the gingival tissue former 100. In this regard, the gingival tissue former 100 may include an inside cavity defined by the aperture 110. For instance, the aperture 110 of the gingival tissue former 100 may extend through a bottom surface of the gingival tissue former 100. Further, the aperture 110 located on the bottom surface (e.g., a coupling assembly 114) of the gingival tissue former 100 may accept an attachment such as, but is not limited to, a dental connector, or dental implant fixture.

In some embodiments, the aperture 110 of the gingival tissue former 100 may be located significantly central to the gingival tissue former 100 so as to securely support a weight of the gingival tissue former 100 onto a dental implant fixture evenly. It is noted that a location of the aperture 110 of the gingival tissue former 100 may change depending on dimension and shape of the gingival tissue former 100 as well as types of a tooth being treated by a dental implant procedure.

In some embodiments, the aperture 110 of the gingival tissue former 100 may have various diameters to accommodate types of a tooth being treated by a dental implant procedure and types of dental implant devices being used during the dental implant procedure. For example, the aperture 110 of the gingival tissue former 100 for a molar tooth may have a wider diameter than that for a bicuspid tooth. By way of another example, the aperture 110 of the gingival tissue former 100 may be configured to be adjustable depending on dimensions of the dental implant devices available to orthodontic surgeons. It is noted that the diameter of the aperture 110 may vary based on a dimension and shape of the dental connector.

It is contemplated that, while the aperture 110 of the gingival tissue former 100 depicted in FIG. 1A has a circle shape, such a configuration is merely provided for illustrative purposes. The embodiments of the present disclosure may be adjusted to have various opening shapes such as, but are not limited to, circle, oval, triangle, square, rectangle, cross, hexagon, or pentagon. In this regard, the aperture 110 of the gingival tissue former 100 may be configured to accept various attachment configurations.

In one embodiment, the gingival tissue former 100 may be a scannable gingival tissue former including a marker 108 (i.e., indentation) located on the edge 112 of the gingival tissue former 100 so as to indicate a scanning geometry reference. For example, the marker 108 of the gingival tissue former 100 may be constructed with a unique geometry such that, when a scan of the gingival tissue former 100 is performed, a modeling software program may automatically orient the gingival tissue former 100 in a proper configuration. In this regard, the marker 108 of the gingival tissue former 100 may ensure to create a digital representation of a patient teeth and provide for the exact position of the dental implant fixture in the scanned model. For instance, the unique geometry of the marker 108 may be an asymmetrical geometry. In another instance, the asymmetrical geometry of the marker 108 of the gingival tissue former 100 may include geometry such as, but is not limited to, a sloped surface, a vertical surface, V-shaped cut, C-shaped cut, or U-shaped cut. It is noted that any kind of unique reproducible structure may be utilized as a marker 108 of the gingival tissue former 100 for automatically orienting the gingival tissue former 100 in a proper configuration during the scanning.

In some embodiments, the marker 108 of the gingival tissue former 100 may be present on multiple locations along the edge 112 of the gingival tissue former 100. For example, one or more markers 108 may be constructed to indicate a scanning geometry such that the locations of the one or more markers 108 provide a proper orientation of the dental implant in the scanned model. By way of another example, a distribution of the one or more markers 108 along the edge 112 of the gingival tissue former 100 may provide asymmetric geometry required for the digital scanning. For instance, the distribution of the one or more markers 108 located on the edge 112 of the gingival tissue former 100 may provide an overall asymmetric geometry to the gingival tissue former 100 so as to allow for the digital scanning to provide for the exact position of the dental implant in the scanned model.

It is contemplated that, while the marker 108 depicted in FIG. 1A is shown as one marking, such a configuration is merely provided for illustrative purposes. Embodiments of the present disclosure may be adjusted to include more than one markings to provide for the exact position of the dental implant fixture in the scanned model. It is further contemplated that, while a shape of the marker 108 depicted in FIG. 1A is shown as V-shaped cut, such a configuration is merely provided for illustrative purposes. Embodiments of the present disclosure may be configured to include various marking shapes to provide for the exact position of the dental implant in the scanned model.

It is noted that, while the marker 108 shown in FIG. 1A is disposed on the edge 112 of the gingival tissue former 100, such a configuration is merely provided for illustrative purposes. Embodiments of the present disclosure may be configured the marker 108 to be disposed on the side surface 104, the top surface 102, or the like to act as a scanning geometry reference.

It is further noted that, while the marker 108 depicted in FIG. 1A is used to indicate a proper orientation of the dental implant in the scanned model, such a configuration is merely provided for illustrative purposes. The embodiments of the present disclosure may be configured to be utilized without the marker 108 on the gingival tissue former 100 as asymmetric shape of the gingival tissue former 100 may act as unique marking for indicating a proper orientation of the dental implant in the scanned model.

In one embodiment, the gingival tissue former 100 includes a side surface 104 (i.e., a lateral surface) extending from a base 106 of the gingival tissue former 100 to the top surface 102 of the gingival tissue former 100 and defining an inside cavity of the gingival tissue former 100. For example, the side surface 104 of the gingival tissue former 100 may be configured to be formed such that the side surface 104 of the gingival tissue former 100 facilitates gingival tissue growth to anatomic form. For instance, the side surface 104 of the gingival tissue former 100 may include some degrees of tapering as the dental implant fixture is typically smaller than teeth so that a circumference of the tooth, as it emerges through the gingival tissue, has tapering up from the depth of the dental implant fixture to the maximum circumference of the tooth. In this regard, a shape of the gingival tissue grown around the dental implant fixture with the gingival tissue former 100 may be similar to anatomic form so that the gingival tissue former 100 solves the aesthetic issues (e.g., black triangle) that may arise from healing abutments (e.g., a transmucosal cylinder shaped abutment).

In some embodiments, the side surface 104 of the gingival tissue former 100 may be configured to adapt a shape of natural tooth. For example, the side surface 104 of the gingival tissue former 100 may be adjusted such that the gingival tissue former 100 does not have tapering. By way of another example, the side surface 104 of the gingival tissue former 100 may be adjusted such that the gingival tissue former 100 has tapering up on some portions of the circumference of the gingival tissue former 100. By way of yet another example, the side surface 104 of the gingival tissue former 100 may be adjusted such that the gingival tissue former 100 has tapering up on entire portions of the circumference of the gingival tissue former 100.

In some embodiments, the side surface 104 of the gingival tissue former 100 may be configured to adopt a smooth surface of a natural tooth. For example, the side surface 104 of the gingival tissue former 100 may include natural tooth surface texture so as to mimic a natural tooth and facilitate gingival tissue (i.e., periodontium) contoured to the anatomic form to achieve better aesthetic finish.

It is contemplated that, while the side surface 104 depicted in FIG. 1A is shown to have a wider width toward the top surface 102 of the gingival tissue former 100, such a configuration is merely provided for illustrative purposes. The embodiments of the present disclosure may be adapted to have significantly similar widths from the base 106 of the gingival tissue former 100 to the top surface 102 of the gingival tissue former 100 depending on a type of tooth being treated during the dental implant procedure.

In one embodiment, the gingival tissue former 100 includes a base 106 (i.e., a bottom surface) located an opposite end to the top surface 102 of the gingival tissue former 100 for defining a bottom surface (i. e., a coupling assembly 114) of the gingival tissue former 100 and accepting an attachment. For example, the base 106 of the gingival tissue former 100 may be configured to be removably attached to dental connections. For instance, the dental connections may include, but are not limited to, a stock restorative abutment, Ti-base, or temporary cylinder.

It is noted that, while the base 106 of the gingival tissue former 100 depicted in FIG. 1A shows a tapering angle different from the side surface 104 tapering angle, such a configuration is merely provided for illustrative purposes. Embodiments of the present disclosure may be adapted to have the same tapering angle for the base 106 as the side surface 104 of the gingival tissue former 100. It is contemplated that an extension of the side surface 104 may be configured to be used as the base 106 of the gingival tissue former 100. It is noted that the gingival tissue former 100 of embodiments of the present disclosure may be configured to have a truncated cone shape.

In one embodiment, the gingival tissue former 100 is formed form durable polymers suitable for dental applications. For example, the gingival tissue former 100 may be formed from thermoplastic known in the art capable of being used as dental applications such as, but is not limited to, poly methyl methacrylate (PMMA) (i.e., acrylic or acrylic glass).

In one embodiment, the gingival tissue former 100 is shapeable. For example, the gingival tissue former 100 may be grounded, cut, and/or polished to tailor to a tooth of individual patient. In this regard, the shaping the gingival tissue former 100 does not require additional processes requiring outside vendors to custom-fit to both individual gingival tissue dimension and shape to facilitate a dental implant restoration. For instance, the gingival tissue former 100 may be grounded, cut, and/or polished using machines known in the art capable of shaping dental restoration such as, but is not limited to, a dental milling machine.

Now referring to FIG. 1B, FIG. 1B illustrates an elevational side view of a tissue former. In one embodiment, the gingival tissue former 100 includes the side surface 104, the base 106, the marker 108, and the edge 112. The gingival tissue former 100 depicted in FIG. 1B is an example of bicuspid tooth by looking from the side. It is noted that the height, width, and tapering angle of the gingival tissue former 100 may be adjusted depending on types of a tooth being treated during the dental implant procedure so as to tailor to each individual tooth shape and dimension.

Now referring to FIG. 1C, FIG. 1C illustrates an elevational bottom view of a gingival tissue former 100. In one embodiment, the gingival tissue former 100 includes the side surface 104 defining a side wall of the gingival tissue former 100 and the edge 112. In some embodiments, the gingival tissue former 100 includes the marker 108 located on the edge 112 of the gingival tissue former 100 to be utilized as a scanning geometry reference.

In one embodiment, the gingival tissue former 100 includes a coupling assembly 114 located directly underneath the aperture 110 of the gingival tissue former 100 for connecting the gingival tissue former 100 to the dental connector. For example, the coupling assembly 114 may have a larger diameter than the diameter of the first end (i.e., towards the top surface) of the aperture 110 of the gingival tissue former 100 to accept a dental connector (as described below) for connecting the gingival tissue former 100 to the dental implant (as described below) securely.

In one embodiment, the gingival tissue former 100 includes an inner opening 116 of the coupling assembly 114 which is slightly larger than the diameter of the first end of the aperture 110. For example, the coupling assembly 114 may further include a set of holders 118 dividing the inner opening 116 of the coupling assembly 114 into two surface planes (i.e., a first surface plane 120 and a second surface plane 122). For instance, the set of holders 118 may provide space for the dental connector to be engaged within the coupling assembly 114. In another instance, the dental connector for connecting the gingival tissue former 100 to the dental implant fixture may be removably insertable into the inner opening 116 equipped with the set of holders 118 located within the coupling assembly 114 of the gingival tissue former 100. Once a dental connector is engaged with the set of holders 118 located within the coupling assembly 114 of the gingival tissue former 100, the dental connector may be securely held for a firm fitting over the dental implant fixture. Further, a dental connector may be cemented within the inner opening 116 of the coupling assembly 114 of the gingival tissue former 100 so as to increase stability between the gingival tissue former 100 and the dental connector.

In one embodiment, the gingival tissue former 100 includes a first surface plane 120 and a second surface plane 122 within the coupling assembly 114 for preventing the dental connector engaged within the set of holders 118 from sliding out. For example, the first surface plane 120 and the second surface plane 122 within the coupling assembly 114 may not occupy the same plane for increasing the stability of the dental connector. For instance, the dental connector may snuggly fit into the inner opening 116 equipped with the set of holders 118 surrounded by the first surface plane 120 and the second surface plane 122 within the coupling assembly 114.

It is contemplated that, while the set of holders 118 depicted in FIG. 1C has two cavities within the coupling assembly 114, such a configuration is merely provided for illustrative purposes. The embodiments of the present disclosure may adapt any number of holders located within the coupling assembly 114 for securely holding the dental connector such as, but is not limited to, one, three, or more cavities. It is further contemplated that a spatial relationship between cavities of the holders 118 depicted in FIG. 1C is merely provided for illustrative purposes. Embodiments of the present disclosure may be adapted to include various spatial arrangements of the holders 118 within the coupling assembly 114 so as to accommodate various dental connector configurations.

It is further contemplated that, while the first surface plane 120 and the second surface plane 122 within the coupling assembly 114 depicted in FIG. 1C are shown to occupy two different planes, such a configuration is merely provided for illustrative purposes. Embodiments of the present disclosure may be adapted to include other configurations of the inner planes such as, but not limited to, three or more different planes within the coupling assembly 114.

It is noted that a diameter of the coupling assembly 114 may vary based on types of a tooth being treated during the dental implant procedure. For example, the diameter of the coupling assembly 114 may be smaller for smaller tooth size. By way of another example, the diameter of the coupling assembly 114 may vary based on a dimension and configuration of the dental connector which connects the gingival tissue former 100 to the dental implant fixture.

It is noted that the dental connector that is engaged within the coupling assembly 114 for connecting the gingival tissue former 100 to the dental implant may include dental connectors known in the art capable of providing connection between the dental implant fixture and the tissue former (i.e., an abutment) such as, but is not limited to, a stock restorative abutment, Ti-base, or temporary cylinder. It is further noted that a dental connector such as a stock restorative abutment, Ti-base, or temporary cylinder has an internal hex connection insertable into the dental implant fixture such that its position can be reproduced in a particular orientation. Additionally, while the gingival tissue former 100 may be specifically configured to correspond to various teeth geometries, the coupling assembly 114 of the gingival tissue former 100 may be universal with respect to the dental connector such as a stock restorative abutment, Ti-base, or temporary cylinder such that different shaped coupling assembly 114 of the gingival tissue former 100 can be placed on any dental connectors.

It is noted that the dental connectors have an angular component to the design so that the gingival tissue former 100 may fit in a particular orientation. For example, the gingival tissue former 100 may fit the dental connector by simply pushing the dental connector into the coupling assembly 114 of the gingival tissue former 100.

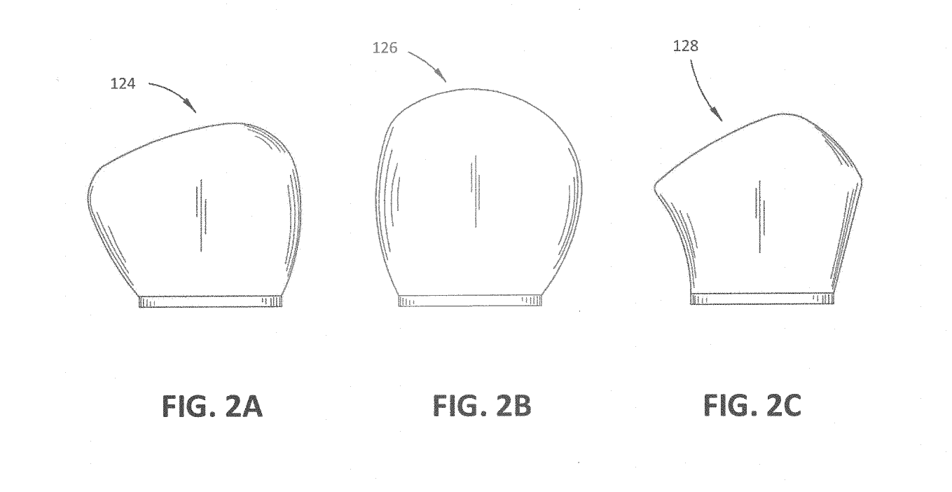

Now referring to FIGS. 2A-2C, FIGS. 2A-2C illustrate elevational side views of alternative shapes of the gingival tissue former 100. As described herein, the shape and dimension of the gingival tissue former 100 may vary depending on types of a tooth being treated during the dental implant procedure. The gingival tissue formers 124, 126, and 128 may be configured to facilitate gingival tissue growth to anatomic form of specific tooth allowing for better aesthetic result after the dental implant procedure.

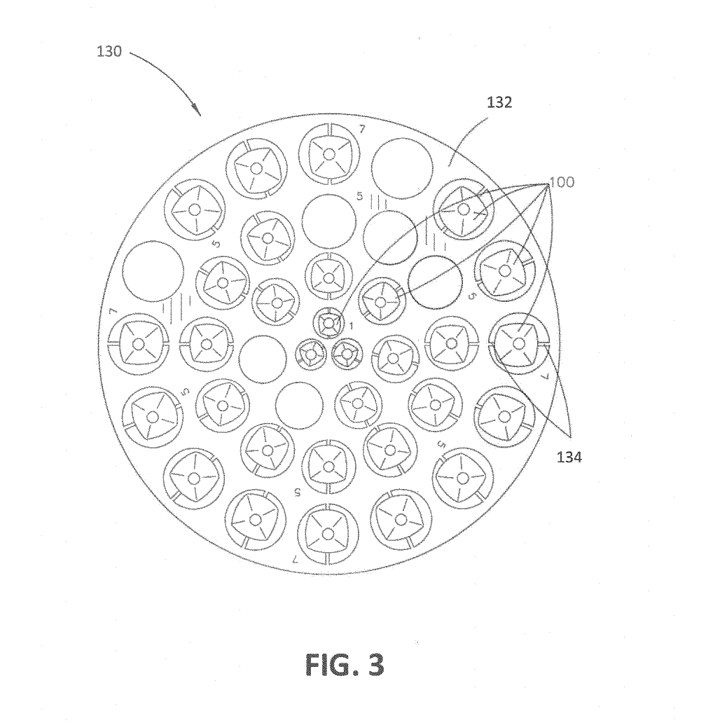

Now referring to FIG. 3, FIG. 3 illustrates a gingival tissue former kit 130. In one embodiment, the gingival tissue former kit 130 includes more than one gingival tissue formers 100 as a set. For example, the gingival tissue former kit 130 may include the gingival tissue formers 100 for all of the teeth for a patient. For instance, the gingival tissue former kit 130 may include 32 teeth including 8 incisors, 4 canines, 8 premolars, and 12 molars for an adult. Further, the gingival tissue former kit 130 may include the gingival tissue formers 100 for more than one person.

In some embodiments, the gingival tissue formers 100 of the gingival tissue former kit 130 may be organized such that the same type (e.g., incisors, canines, premolars, or molars) of the gingival tissue formers 100 are positioned on a certain portion of a frame 132 of the gingival tissue former kit 130. In some embodiments, the gingival tissue formers 100 of the gingival tissue former kit 130 may be organized according to a teeth anatomical diagram (e.g., upper gingival tissue formers and lower gingival tissue formers) in the frame 132 of the gingival tissue former kit 130. In some embodiments, the gingival tissue formers 100 of the gingival tissue former kit 130 may be associated with teeth numbers based on a teeth numbers chart and organized accordingly (e.g., upper left quadrant, upper right quadrant, lower left quadrant, and lower right quadrant) in the frame 132 of the gingival tissue former kit 130. For example, the teeth numbers of each gingival tissue formers 100 of the gingival tissue former kit 130 may be indicated on the frame 132 of the gingival tissue former kit 130.

In some embodiments, the gingival tissue formers 100 of the gingival tissue former kit 130 may be easily detachable from the frame 132 of the gingival tissue former kit 130. For example, the gingival tissue formers 100 of the gingival tissue former kit 130 may be held with attachment members 134 connected to the frame 132 of the gingival tissue former kit 130. In this regard, the attachment members 134 provide a holding mechanism for the gingival tissue former 100 allowing for an easy detachment from the frame 132 of the gingival tissue former kit 130. For instance, the gingival tissue former 100 may be detached by cutting or manually breaking the attachment members 134 from the frame 132 which holds gingival tissue former 100. It is noted that a surface of the gingival tissue former 100 may be milled to provide a smooth surface after the detachment from the frame 132.

In some embodiments, the gingival tissue former kit 130 is formed from the same material used to form the gingival tissue former 100. For example, the gingival tissue former kit 130 may be formed from durable polymers suitable for dental applications. For instance, the gingival tissue former kit 130 may be formed from thermoplastic known in the art capable of being used as dental applications such as, but is not limited to, poly methyl methacrylate (PMMA) (i.e., acrylic or acrylic glass). Further, the gingival tissue former kit 130 may be formed by an industrial process including, but is not limited to, an injection molding or a press machine. It is noted that the gingival tissue former 100 of the gingival tissue former kit 130 may come with minimally over-contoured so as that the gingival tissue former 100 can be ground, cut, and/or polished to ideal form prior to the application.

It is contemplated that, while the attachment members 134 depicted in FIG. 3 are shown as two attachments holding each of the gingival tissue former 100, such a configuration is merely provided for illustrative purposes. The embodiments of the present disclosure may be adapted to include more than two attachments for each of the gingival tissue former 100 in the gingival tissue former kit 130.

It is further contemplated that, while the gingival tissue former kit 130 depicted in FIG. 3 shows empty spaces, such a configuration is merely provided for illustrative purposes. The embodiments of the present disclosure may be configured to have the gingival tissue formers 100in every spot in the gingival tissue former kit 130.

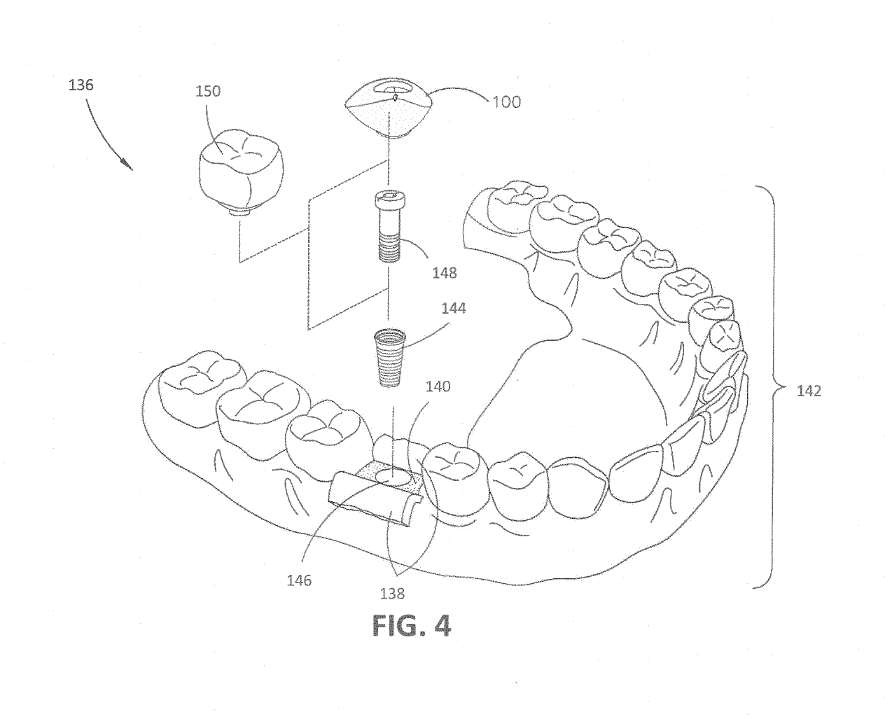

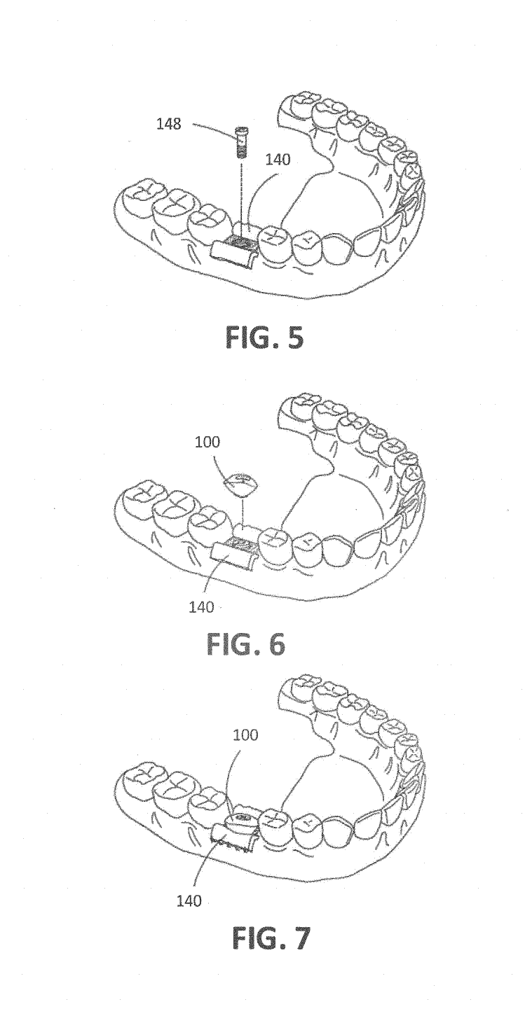

Now referring to FIGS. 4-10, FIG. 4 illustrates a dental implant assembly 136 including a gingival tissue former 100. FIGS. 5-10 illustrate steps of a dental restoration procedure using the gingival tissue former 100. In one embodiment, a surgical incision is made over gingival tissue 138 to expose a portion of a jawbone 140 (maxilla or mandible) at a location corresponding to a previously extracted tooth 142. A dental implant 144 may be placed within a hole 146 drilled in the jawbone 140. In order to cover an opening of the dental implant 144, a dental connector 148 may be applied over the dental implant 144. For example, the dental connector 148 may include any known dental connector configured to connect the dental implant 144 to an abutment (e.g., the gingival tissue former 100) including, but are not limited to, a stock restorative abutment, Ti-base, or temporary cylinder. The dental connector 148 may be screwed into the dental implant 144a (e.g., as shown in FIG. 5).

Further, the dental implant assembly 136 may include a gingival tissue former 100 which is applied over the dental connector 148 (e.g., FIG. 6) at the time of a dental implant surgery. After placement of the gingival tissue former 100 over the dental connector 148, the gingival tissue 138 may be sutured up (e.g., FIG. 7). During osseointegration (e.g., 3-6 months), the gingival tissue 138 may be contoured based on a shape of the gingival tissue former 100 and grown to adapt anatomic form. It is noted that during the osseointegration the gingival tissue former 100 may be left in place. The optical scan may be obtained for fabrication of a final restoration at the time of dental implant placement, during the osseointegration, or after the osseointegration is completed. In this regard, embodiments of the present disclosure may simplify steps of taking the optical scan by using the integrated scan body functionality of the gingival tissue former 100 due to a uniquely designed geometric pattern (e.g., the marker 108 or indentation) located on the most incisal or occlusal surface. The embodiments of the present disclosure may remove steps of removing a healing abutment (e.g., the gingival tissue former 100 and the dental connector 148), placing a transfer coping screwed into the dental implant 144, taking an impression, and generating a model using the impression taken. In this regard, a traditional or a cylinder-shaped healing abutment with a scan body is not used in embodiments of the present disclosure. The gingival tissue former 100 with shapeable functionality which slides over the dental connector is used.

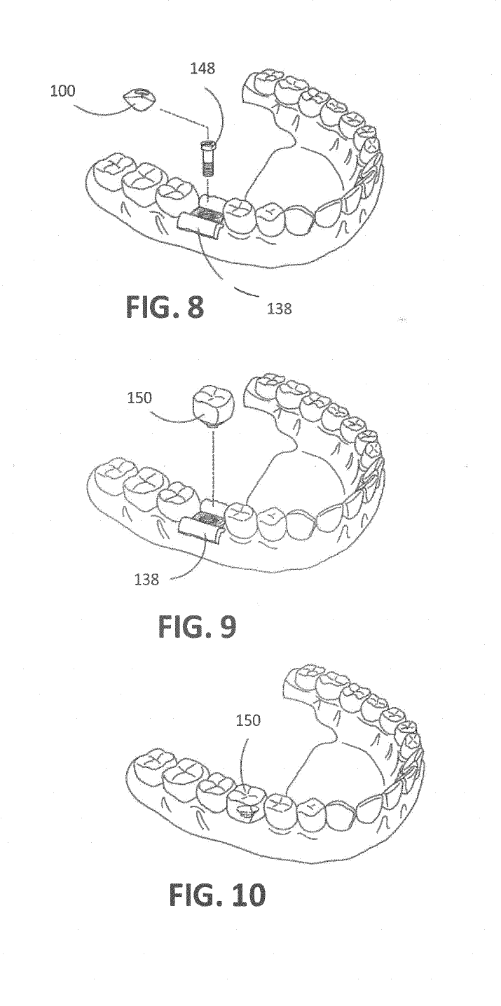

Referring again to FIGS. 4-10, it is further noted that, while the dental connector 148 that is inserted into the dental implant 144 may be permanent (e.g., couplable to the final restoration), the gingival tissue former 100 may be removable from the dental connector 148 following healing and prior to insertion of the final restoration (e.g., FIG. 8).

Following healing, the gingival tissue former 100 may be removed and then a restoration 150 (e.g., a crown) may be attached to the dental connector 148. Alternatively, the gingival tissue former 100 and the dental connector 148 may be removed entirely (e.g., FIG. 8) and a new restoration 150 may be inserted directly into the dental implant 144 (e.g., FIGS. 9-10).

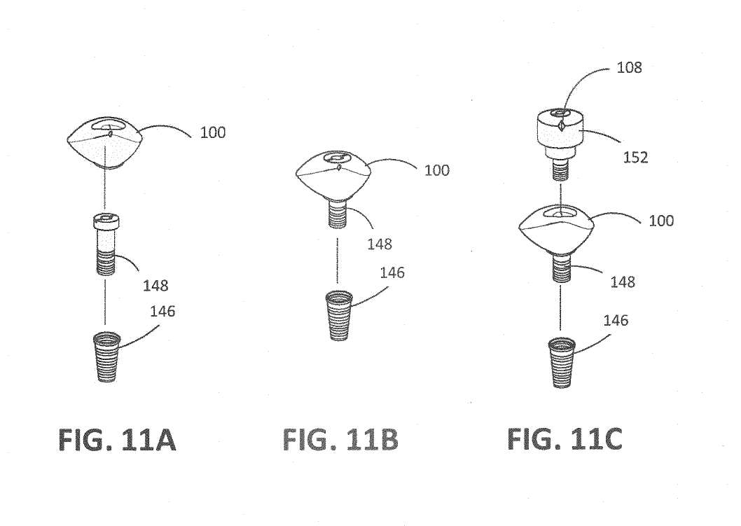

Referring now to FIGS. 11A-11C, FIG. 11A illustrates an installation method of a gingival tissue forming system. As shown in FIG. 4, a dental implant 144 may be installed in the jawbone 140. A dental connector 148 may be inserted or screwed into the dental implant 144. Then, the gingival tissue former 100 may be applied over the dental connector 148 at the time of a dental implant surgery. The dental connector 148 and the gingival tissue former 100 may be installed separately.

FIG. 11B illustrates a second installation method of a gingival tissue forming system. First, the dental implant 144 may be installed in the jawbone 140. The gingival tissue former 100 and the dental connector 148 may be pre-coupled or fabricated as a single piece. The single-piece unit (the combined gingival tissue former 100 and the dental connector 148) may then be applied over the dental implant 144. This may save time and further simplify the restorative procedure. It is noted that the gingival tissue former 100 and the dental connector 148 may be cemented together prior to the installation. It is also noted that the gingival tissue former 100 and the dental connector 148 may be held together with an engagement mechanism described in FIG. 1C. Additionally, it is noted that the gingival tissue former 100 and the dental connector 148 may be snugly fit together by pressing. Still further, the gingival tissue former 100 and the dental connector 148 may be integrally constructed (e.g. as a single-piece formed thermoplastic or metal structure operably couplable directly to the dental implant fixture).

FIG. 11C illustrates a third installation method of a gingival tissue forming system. The gingival tissue former 100 and the dental connector 148 may be separately installed, as described in FIG. 11A, or pre-installed, as described in FIG. 11B. In one embodiment, the gingival tissue former 100 shown in FIG. 11C may not possess the marker 108 (i.e., an indentation). Instead, a scan body 152 with a geometrical marker 108 may be applied over the gingival tissue former 100 and operate as a geometry reference for a three-dimensional scanned model of a patient. For example, a gingival tissue former 100 and/or a dental connector 148 may include an threaded aperture configured to receive the scan body 152. It is contemplated that, while a cylindrical scan body 152 shown in FIG. 11C is utilized, such a configuration is merely provided for illustrative purposes. Embodiments of the present disclosure may be configured to utilize any scan body used in the dental implant field to give the necessary geometry reference for a three-dimensional scanned model of a patient.

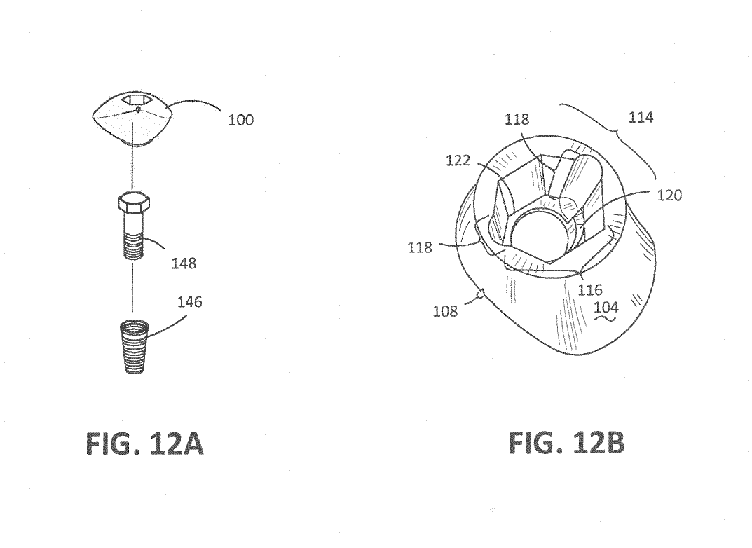

Referring now to FIGS. 12A-12B, FIG. 12A illustrates another coupling method between a gingival tissue former 100 and a dental connector 148. In one embodiment, a gingival tissue former 100 accommodates a hex connection for coupling with a dental connector 148. For example, the coupling assembly 114 of the gingival tissue former 100 may include an internal hex structure as shown in FIG. 12B. Correspondingly, the dental connector 148 may be equipped with a hex head to couple with the gingival tissue former 100. In this regard, embodiments of the present disclosure may be configured to utilize any gingival tissue former 100 and/or dental connector 148 (i.e., On1™).

It is noted that the gingival tissue former 100 and the dental connector 148 described in the installation methods in FIGS. 11A-12B may include a stopper (not shown) that may be placed inside of the gingival tissue former 100 and/or inside the head of the dental connector 148 such that the stopper prevents the gingival tissue former 100 from sliding up or down relative to the dental connector 148. Alternately, the stopper may be configured to hold the gingival tissue former 100 and/or the dental connector 148. Further, the stopper may be configured to be an indicator for how the gingival tissue former 100 and the dental connector 148 couple together.

In order to configure the structure of an individual gingival tissue former 100 to distinct tooth types, both a computed tomography (CT) scan and an intraoral digital scan of an individual can be performed. The intraoral digital scan may be merged onto the CT scan to allow for virtual placement of the implants on the CT scan to reflect where the dental implant fixture would ideally be placed in a patient. A confirmation may be created as to how the tissue would be merged to create the natural shape as it is passing through the gingiva tissue. Additionally, in the digital model, an actual tooth may be overlaid to see how the dental implant fixture would be positioned as would be desired.

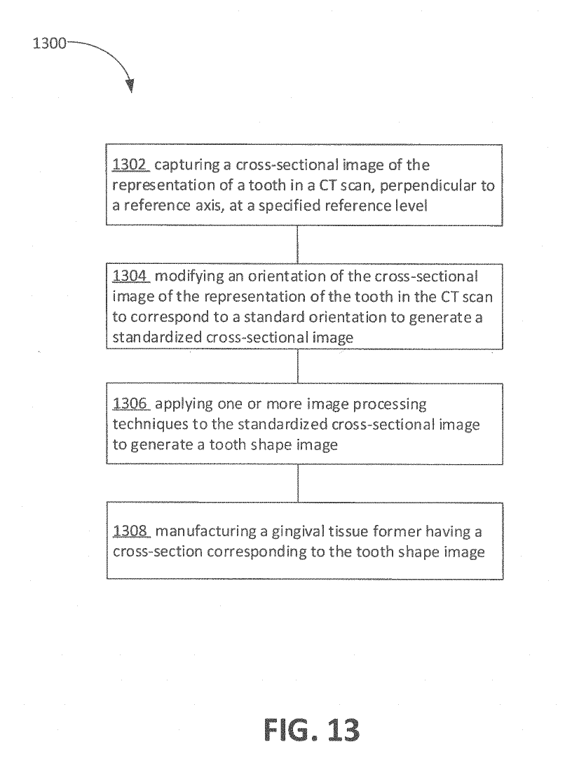

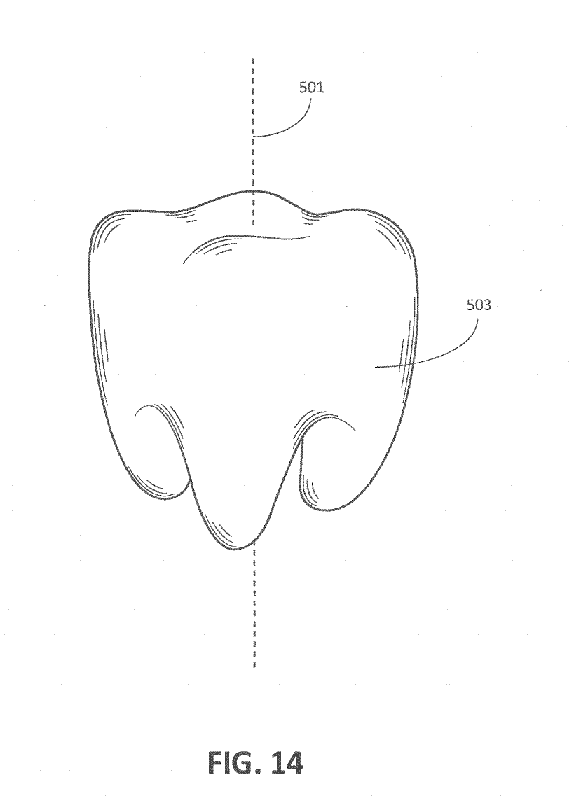

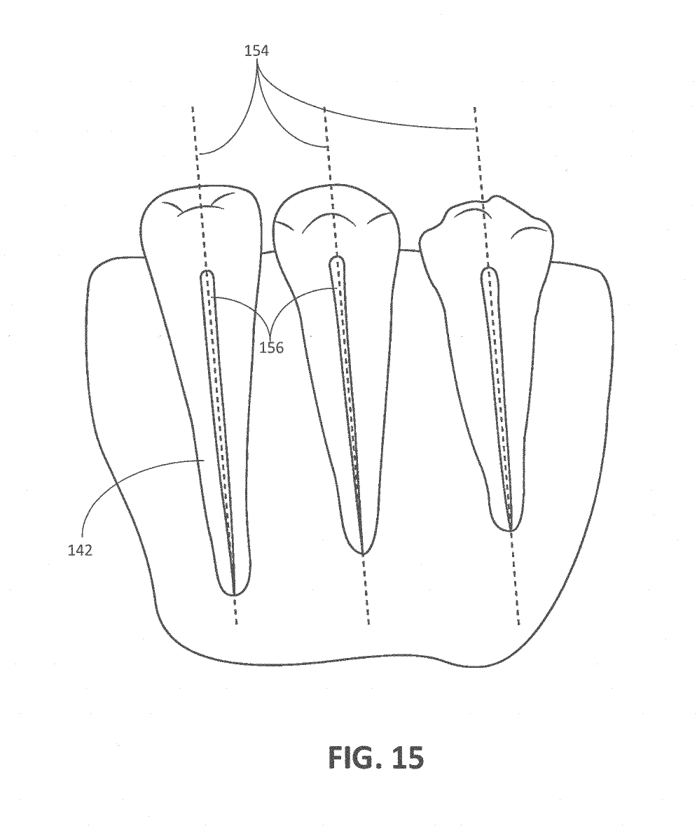

It may be desirable to provide standardized gingival tissue formers 100 which may be employed for a variety of patients having varying oral structures. In order to ascertain standardized implant positioning for the development of anatomic root-form, gingival tissue formers 100, intra-oral scans may be merged to patient-specific CT scans. Implant planning software (e.g. Dental System software from 3Shape) may then be used in conjunction with the merged scans. Statistical norms in tooth geometries and/or implant positioning may then be determined from an analysis of a significant volume of patient data to construct generic, standardized gingival tissue formers 100. For example, the analysis may include a process 1300 shown in FIG. 13.

Referring to FIG. 13, at an operation 1302, following acquisition of a CT scan of a patient, a cross-sectional image of a representation of a tooth in the CT scan by be captured, perpendicular to a reference axis and at a specified reference level of the tooth.

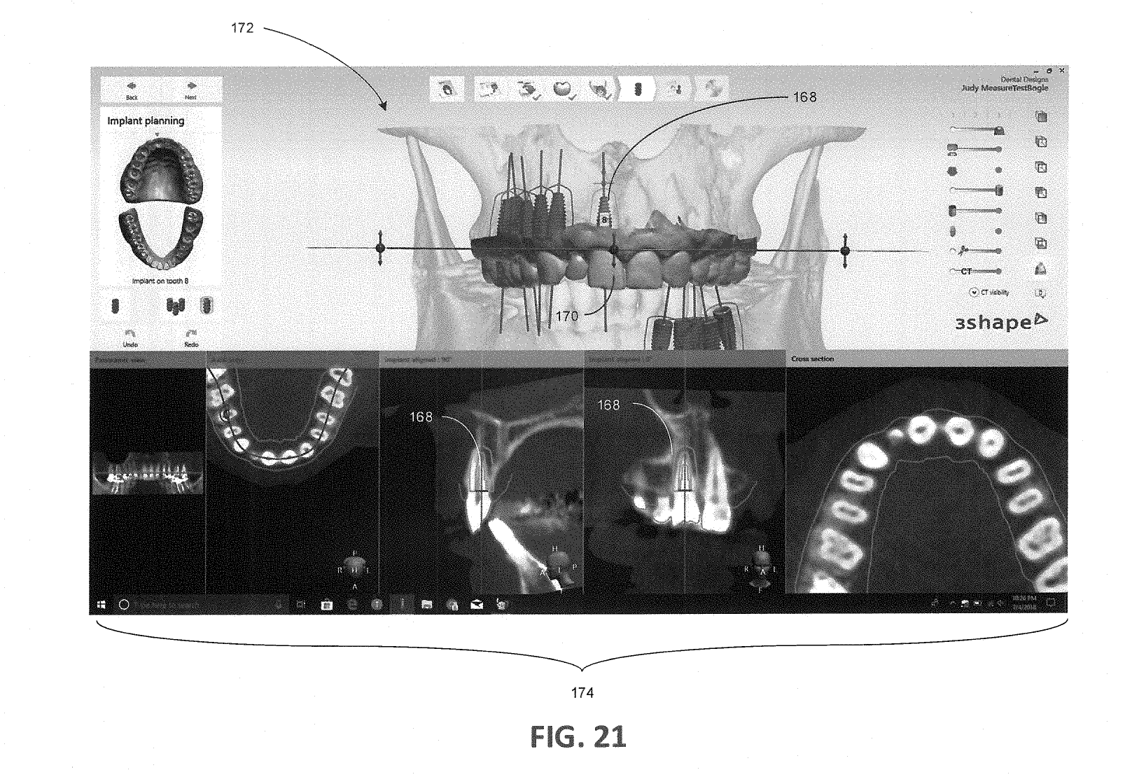

Initially, a reference coordinate set may be defined for a particular tooth in the CT scan. For example, as shown in FIGS. 14 and 15, a reference axis 154 may correspond to the anatomic long axis of a root 156 of a given tooth 142. As shown in FIG. 15, the orientation of the reference axis 154 may vary (e.g. be canted facially or lingually, be canted distally or mesial, or some combination thereof) between teeth of a single patient or between common teeth (e.g. between molars, between incisors, etc.) of multiple patients. Alternately, the reference axis 154 may be defined by the orientation of a primary axis of an implant virtually positioned with respect to the CT and/or optical scan for a patient (e.g. as shown in FIG. 21). Specifically, as shown in FIG. 12, the reference axis 154 may be overlaid on the CT scan representation utilizing any number of computer modeling tools (e.g. Dental System software from 3Shape).

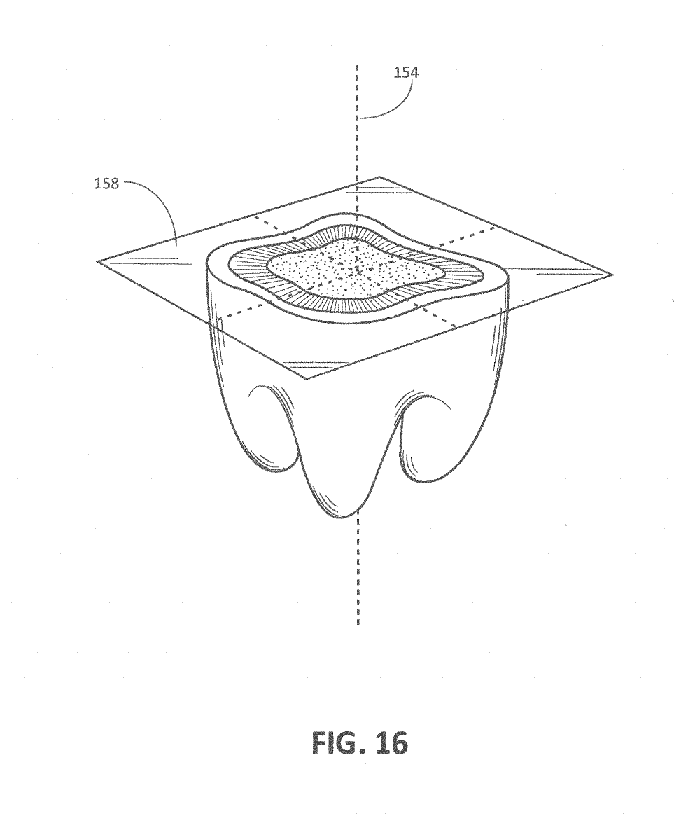

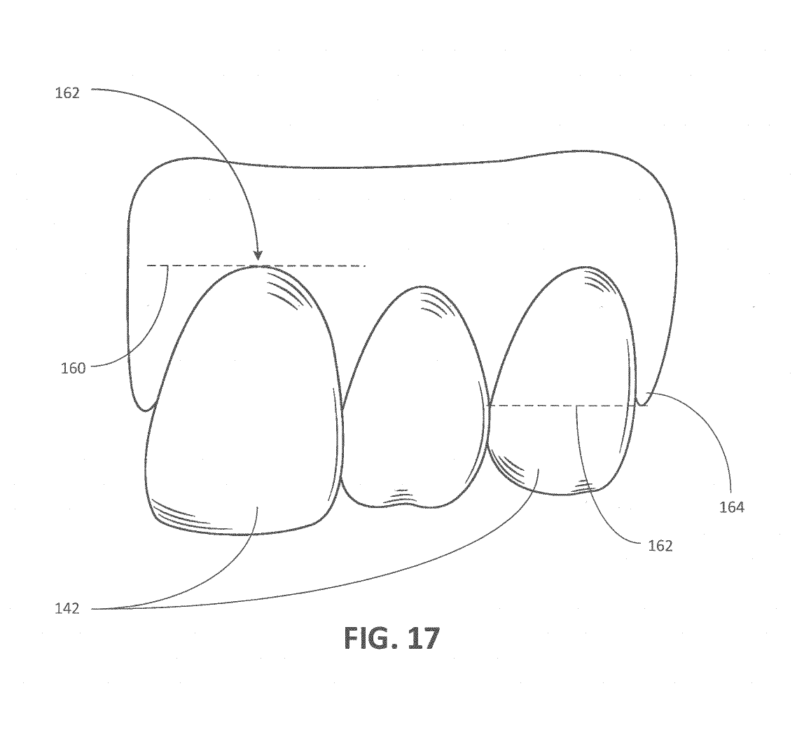

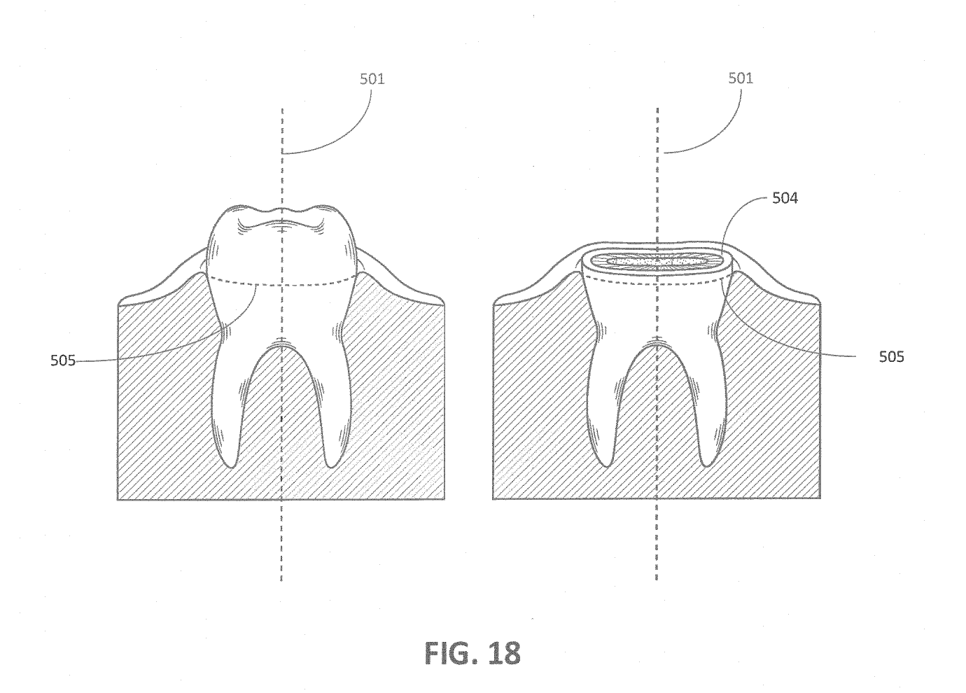

Referring again to FIG. 13 and to FIGS. 16-19A-C, at an operation 1306, following establishment of the reference axis 154, a planar, cross-sectional image 158 of the CT scan representation, perpendicular to the reference axis 154 of a tooth 142, may be captured (e.g. via implant planning software) at a specified reference level 160 of the tooth 142. For example, as shown in FIGS. 14-15, the reference level 160 may be defined at the facial gingival zenith 162 of a tooth, the gingival papilla 164 of a tooth, or any other desired level.

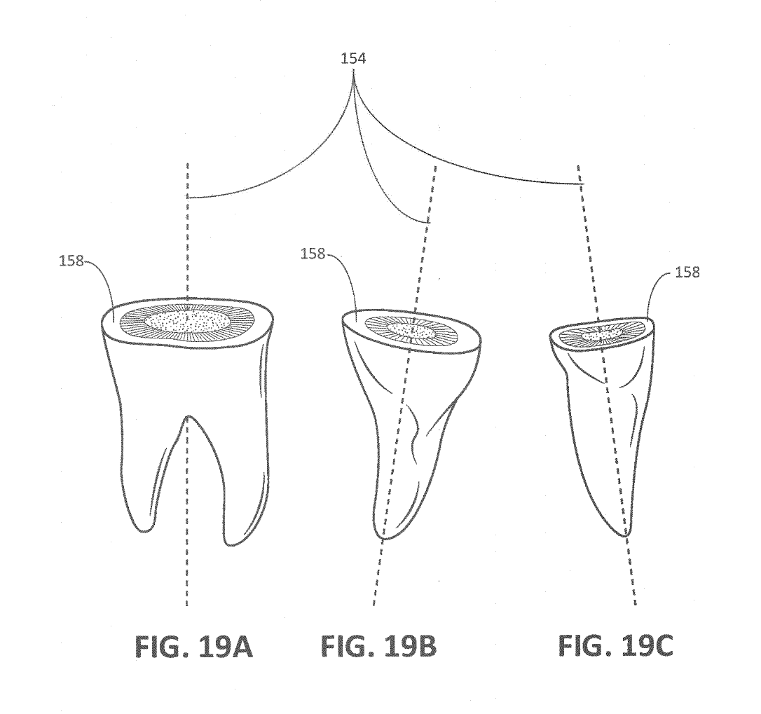

As further shown in FIGS. 19A-C, the cross-sectional image 158 may be perpendicular to the reference axis 154. As such, the cross-sectional image 158 may substantially horizontal (see FIG. 16A) or may be canted according to the orientation of the reference axis 154 (see FIGS. 16B-C).

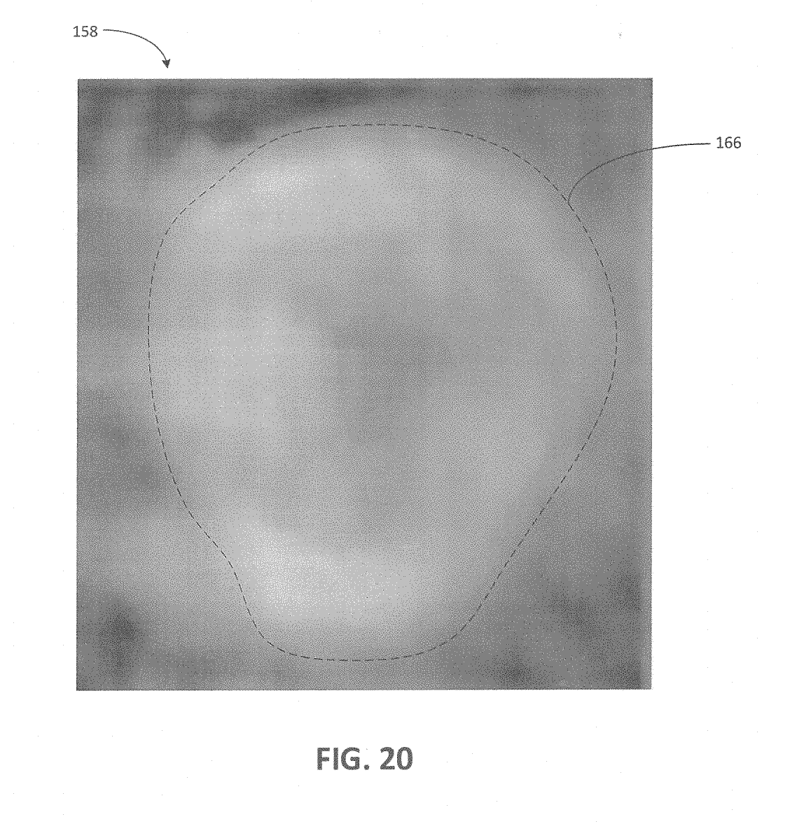

Referring again to FIG. 13, at an operation 1306, following capture of a cross-sectional image 158 of the CT scan at the desired reference level 160, the cross-sectional image 158 sizing and rotational parameters of the cross-sectional image 158 may be adjusted to standardize the orientation of the tooth to allow for the determination of a tooth boundary 166 (as shown in FIG. 20) defining the shape of the tooth 142 at the desired reference level 160 in a standardized reference space.

For example, as shown in FIG. 21, implant positioning modeling software may be employed to overlay a digital representation of an implant relative to a CT and/or optical scan of a given tooth. As shown in FIG. 21, a virtual representation of a dental implant 168 is positioned relative to a representation of a tooth 170 in an optical scan 172. The position of the virtual representation of a dental implant 168 is also shown relative to a tooth 170 in a CT scan 174.

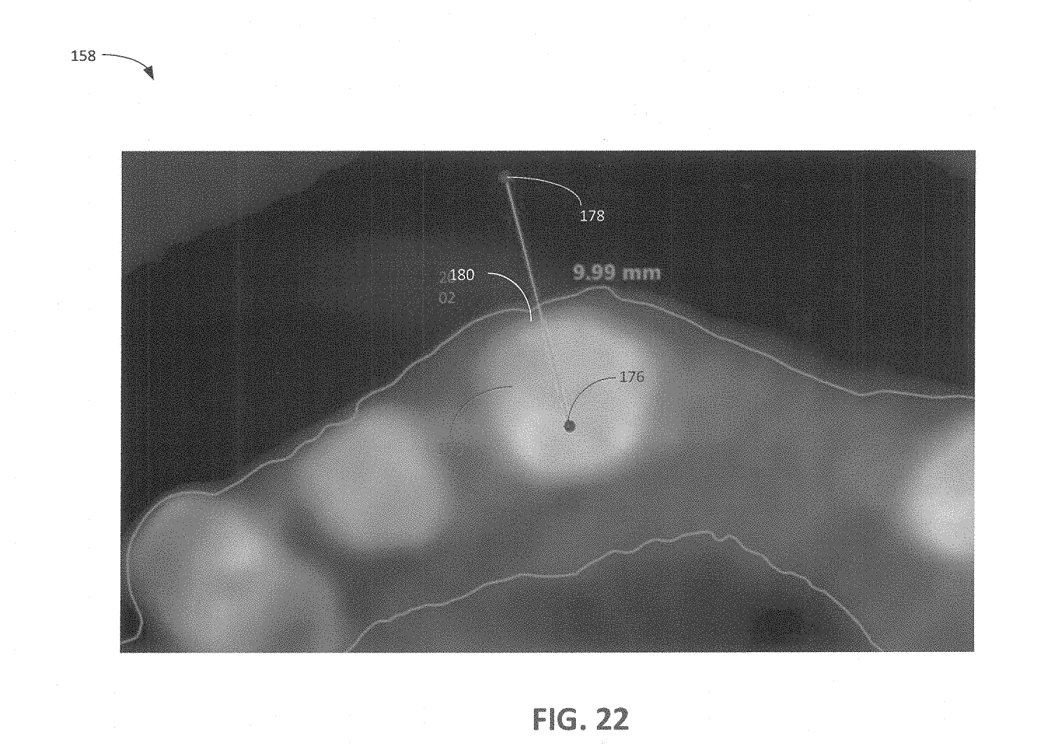

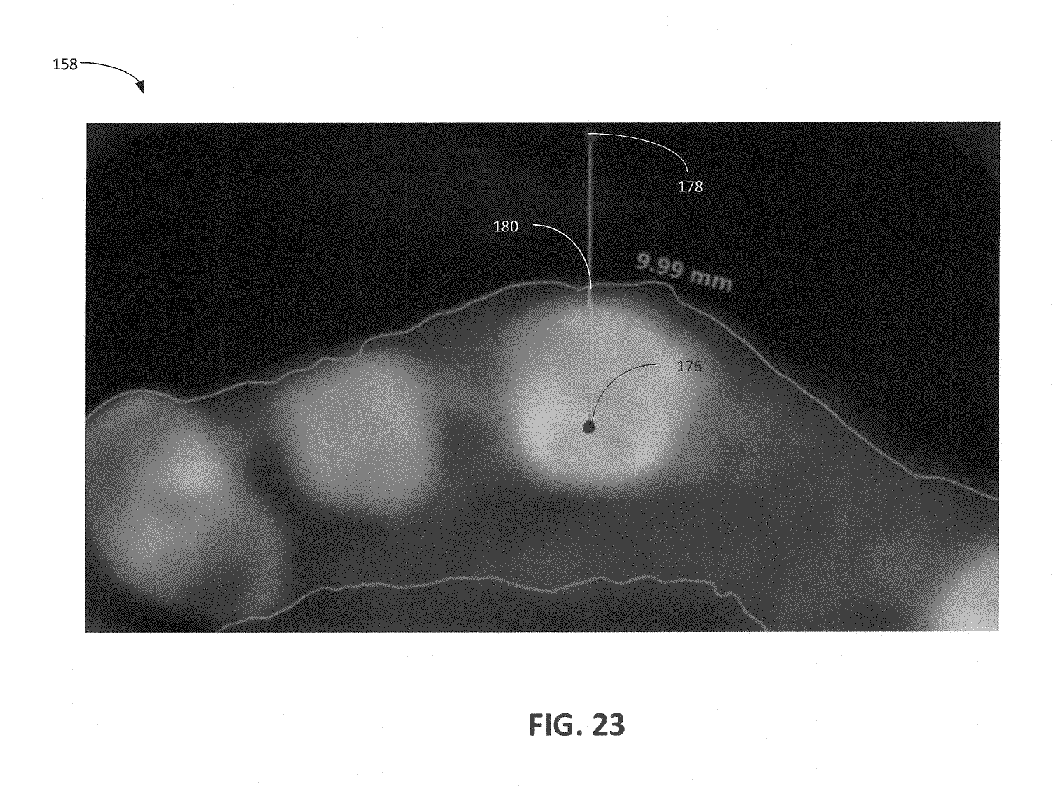

Referring to FIG. 22, a coordinate system specifying a reference space may be established for a cross-sectional image 158 that is defined by a first reference point 176 corresponding to a central axis of the virtual representation of a dental implant 168 and a second reference point 178 located a defined distance (e.g. about 1 cm) away from the second reference point 178 along a line extending radially from the first reference point 176 and perpendicularly intersecting the buccal surface 180 of the tooth 170 perpendicularly. As shown in FIG. 23, To facilitate comparison between patient scan samples, each cross-sectional image 158 may be rotated to a standard orientation (e.g. a line joining the first reference point 176 and the second reference point 178 is oriented vertically such that the buccal surface 180 faces up).

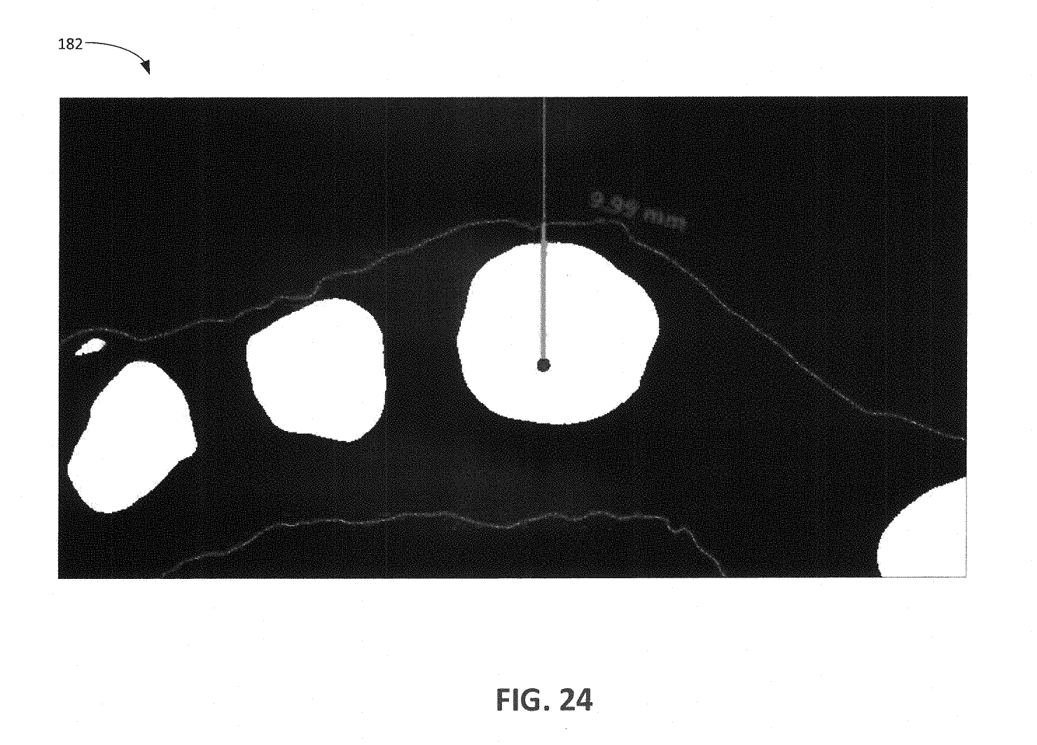

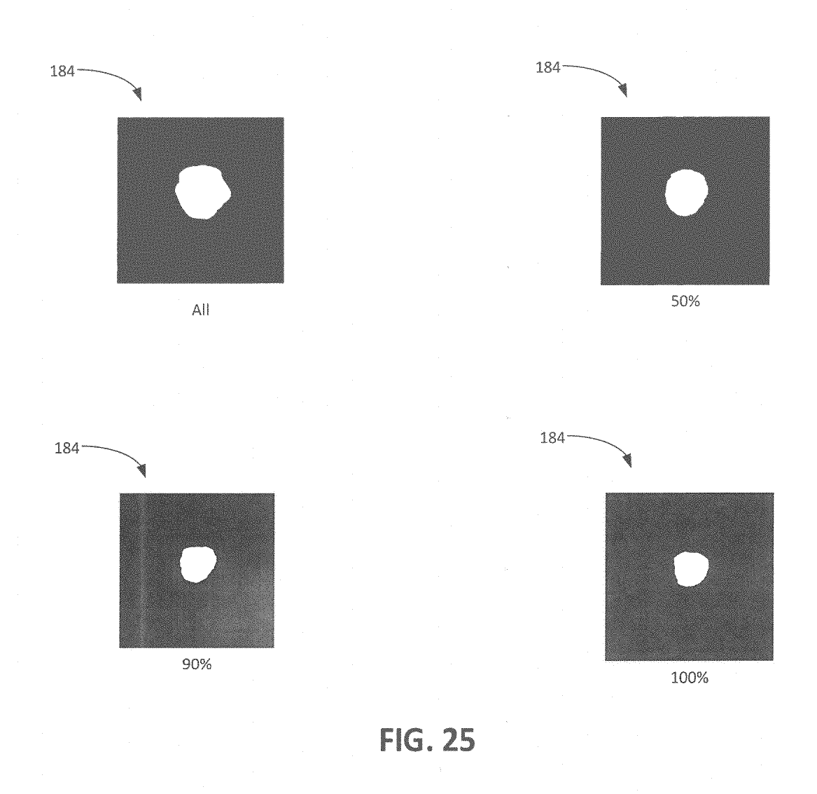

Referring again to FIG. 13, following orientation of the cross-sectional image 158, at an operation 1306, one or more image processing techniques may be employed to the cross-sectional image 158 to isolate a tooth shape of a given tooth. In one embodiment, thresholding processing may be applied to a cross-sectional image 158 constituting a greyscale CT image having the standardized orientation. Such image processing may include, but is not limited to, comparison of pixel characteristic (e.g. color or intensity) to one or more thresholds, determination of a measure of pixels per unit area (e.g. a percentage of pixels having a given characteristic (e.g. color or intensity) per unit area), and the like. For example, as shown in FIG. 24, a thresholding process may replace each pixel in the cross-sectional image 158 of FIG. 23 with a first pixel type (e.g. a black pixel) if the image intensity is less than some fixed constant value (e.g. less than 75% intensity), or a second pixel type (e.g. a white pixel) if the image intensity is greater than that constant value (>75% intensity) to generate a binary tooth shape image 182. If necessary, the resulting binary image may be cropped, disposed on a black background and rescaled to a common pixels-to-length ration (e.g. 200 px/cm).

Referring again to FIG. 13, following determination of the tooth shape image 182 for a given tooth the tooth shape image 182 may be provided as a sample to a statistical analysis to determine an average or standard sizing of a tooth boundary to be translated to a manufactured gingival tissue former 100, which may be employed for a variety of patients having varying oral structures. Such an analysis may include overlaying multiple tooth shape images 182 (having a standardized orientation and sizing).

A thresholding process may be applied to the multiple tooth shape images (e.g. for a common tooth location for multiple patients) to generate a composite tooth shape image 184. For example, a pixel-based analysis may be performed where, if a threshold percentage of the multiple tooth shape images 182 have a pixel at a common location that is indicative of the presence of a tooth (e.g. a white pixel), the composite tooth shape image will have a pixel indicating a presence of a tooth at that location (e.g. a white pixel). Alternately, if less than the threshold percentage of the multiple tooth shape images 182 have a pixel at the common location that is indicative of the presence of a tooth (e.g. a white pixel), the composite tooth shape image will have a pixel indicating an absence of a tooth at that location (e.g. a black pixel).

Specifically, as shown in FIGS. 25-28, a different threshold percentage may result in a different composite tooth shape image 184. Referring to FIG. 25, a composite tooth shape image 184 for all sample tooth shape images 182 is shown. In this case, any sample tooth shape image 182 having a given pixel indicating the presence of a tooth will result in a corresponding pixel indicating the presence of a tooth in the composite tooth shape image 184. Referring to FIG. 26, a composite tooth shape image 184 is shown having a 50% threshold. In this case, a pixel in the composite tooth shape image 184 will only reflect the presence of a tooth if at least 50% of the sample tooth shape images 182 indicate a corresponding pixel indicating the presence of the tooth. Referring to FIG. 27, a composite tooth shape image 184 is shown having a 90% threshold. In this case, a pixel in the composite tooth shape image 184 will only reflect the presence of a tooth if at least 90% of the sample tooth shape images 182 indicate a corresponding pixel indicating the presence of the tooth. Referring to FIG. 28, a composite tooth shape image 184 is shown having a 100% threshold. In this case, a pixel in the composite tooth shape image 184 will only reflect the presence of a tooth if every sample tooth shape image 182 indicate a corresponding pixel indicating the presence of the tooth.

Referring again to FIG. 13, at an operation 1308, following determination of a composite tooth shape image 184, a design specifications for a gingival tissue former 100 may be established such that the dimensions of composite tooth shape image 184 may be mapped to a cross-sectional area of the gingival tissue former 100 (e.g. a maximum cross-sectional area). For example, a gingival tissue former 100 may be manufactured (e.g. via milling, injection molding, etc.) having an edge 112 shape corresponding to the standard sizing at a height (relative to the base 106) equal to a reference level 160 (e.g. the facial gingival zenith 162, the gingival papilla 164, etc.). The overall height of gingival tissue former 100 may be configured such that the gingival tissue former 100 projects from an dental implant 144 a desired distance (e.g. 4 mm) when coupled to a dental connector 148 inserted into the dental implant 144. The gingival tissue former 100 may have linear or curvilinear sides (e.g. concave and/or convex) which taper from the top surface 102 to a width approximately equal to that of the dental implant 144. The top surface 102 may be substantially planar or curved and oriented substantially perpendicular to a primary axis defined by a dental connector 148 to which the gingival tissue former 100 can be coupled.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed:

1. A process for providing a gingival tissue former, the process comprising:
capturing a cross-sectional image of a representation of a tooth in a digital scan, perpendicular to a reference axis, at a specified reference level;
modifying an orientation of the cross-sectional image to correspond to a standard orientation;
applying one or more image processing techniques to the cross-sectional image to generate a tooth shape image; and
mapping the tooth shape image to one or more design specifications for a gingival tissue former.

2. The process of claim 1, wherein the digital scan includes:
a computed tomography (CT) scan.

3. The process of claim 1, wherein the reference axis includes:
a reference axis corresponding to an anatomic long axis of a root of the tooth in the digital scan.

4. The process of claim 1, wherein the reference level includes:
a reference level corresponding to at least of a facial gingival zenith of the tooth in the digital scan or a gingival papilla of the tooth in the digital scan.

5. The process of claim 1, wherein the modifying an orientation of the cross-sectional image to correspond to a standard orientation includes:
defining a first reference point corresponding to a central axis of a virtual representation of a dental implant overlaid on the tooth in the digital scan;
defining a second reference point a defined distance away from the first reference point along a line extending radially from the first reference point and perpendicularly intersecting a buccal surface of the tooth in the digital scan; and
rotating the cross-sectional image of the representation of the tooth in the digital scan to a standard alignment of the first reference point and the second reference point.

6. The process of claim 1, wherein the applying one or more image processing techniques to the cross-sectional image to generate a tooth shape image includes:
at least one of: comparison of pixel color or intensity to at least one threshold, or computing a measure of pixels per unit area.

7. The process of claim 1, wherein the applying one or more image processing techniques to the cross-sectional image to generate a tooth shape image includes:
generating a binary tooth shape image according to one or more pixel characteristics of the cross-sectional image.

8. The process of claim 7, wherein the generating a binary tooth shape image according to one or more pixel characteristics of the cross-sectional image includes:
replacing a pixel of the cross-sectional image with a first pixel type if the pixel of the cross-sectional image has one or more pixel characteristics; and
replacing the pixel of the cross-sectional image with a second pixel type if the pixel of the cross-sectional image does not have the one or more pixel characteristics.

9. The process of claim 8, wherein the one or more pixel characteristics include:
a pixel intensity threshold.

10. The process of claim 1, wherein the applying one or more image processing techniques to the cross-sectional image to generate a tooth shape image includes:
obtaining plurality of tooth shape images from digital scans of a plurality of patients, the plurality of tooth shape images having the standard orientation;
applying a thresholding process to the plurality of tooth shape images from the digital scans of the plurality of patients to generate a composite tooth shape image.

11. The process of claim 10, wherein the applying a thresholding process to the plurality of tooth shape images from the digital scans of the plurality of patients to generate a composite tooth shape image includes:
setting a pixel of the composite tooth shape image as a first pixel type if a threshold number of the plurality of tooth shape images has pixel at a common location having a pixel characteristic; and
setting a pixel of the composite tooth shape image as a second pixel type if less than the threshold number of the plurality of tooth shape images has a pixel at the common location having the pixel characteristic.

12. The process of claim 11, wherein the pixel characteristic includes:
a pixel characteristic indicative of a presence of a tooth in the tooth shape image.

13. The process of claim 10, wherein the mapping the tooth shape image to one or more design specifications for a gingival tissue former:
mapping the composite tooth shape image to one or more design specifications for a gingival tissue former.

14. The process of claim 13, wherein the mapping the composite tooth shape image to one or more design specifications for a gingival tissue former includes:
mapping the composite tooth shape image to a maximum cross-sectional area of a gingival tissue former.

15. The process of claim 13, further comprising:
manufacturing a gingival tissue former according to the one or more design specifications for a gingival tissue former.

16. The process of claim 1, wherein the mapping the tooth shape image to one or more design specifications for a gingival tissue former includes:
mapping the composite tooth shape image to a maximum cross-sectional area of a gingival tissue former.

17. The process of claim 1, further comprising:
manufacturing a gingival tissue former according to the one or more design specifications for a gingival tissue former.

18. A gingival tissue former prepared by a process comprising:
capturing a cross-sectional image of a representation of a tooth in a digital scan, perpendicular to a reference axis, at a specified reference level;
modifying an orientation of the cross-sectional image to correspond to a standard orientation;
applying one or more image processing techniques to the cross-sectional image to generate a tooth shape image; and
mapping the tooth shape image to one or more design specifications for a gingival tissue former.

19. A gingival tissue former comprising:
a tissue former having at least a top surface, a lateral surface, and a bottom surface, wherein the tissue former is configured to have at least a truncated shape, the tissue former, further, comprising:
an aperture disposed through the top surface and the bottom surface of the tissue former;
wherein the top surface is dimensioned to correspond to at least one tooth shape image derived from one or more cross-sectional images of one or more patient teeth captured at a specified reference level.
